(19) United States
(12) Patent Application Publication
(10) Pub. No.: US 2022/0288605 A1
(43) Pub. Date: Sep. 15, 2022

(54) Complex depressant for controlling zinc and iron in polymetallic-ore flotation, production process and application as a substitute for zinc sulfates and copper sulfates

(71) Applicant: Felipe José Rey Bustamante, Lima (PE)

(72) Inventor: Felipe José Rey Bustamante, Lima (PE)

(21) Appl. No.: 17/631,331

(22) PCT Filed: Feb. 24, 2020
(86) PCT No.: PCT/PE2020/050004

§ 371 Date: Jan. 28, 2022

(30) Foreign Application Priority Data
Aug. 1, 2019 (PE) 001520-2019/DIN

(51) Int. Cl. B03D 1/016; B03D 1/02; B03D 1/018; B03D 1/008

(52) U.S. Cl. CPC B03D 1/016; B03D 1/02; B03D 1/018; B03D 1/008; B03D 2201/06; B03D 2203/02

(57) ABSTRACT

This proposed invention consists of a process for elaborating a depressant agent, which includes, by weight percentage, dissolving 1-40% humic acid, or humic acid derivatives, in 50-99% water at a temperature between 15-30° C. and solubilizing it by adding 0-10% potassium hydroxide; the temperature will rise due to the solvation of potassium hydroxide (30-45° C.); leaving to react and homogenize for 20-60 minutes; causing the latter product to react with 0.1-15% of fulvic acid to generate a product that controls zinc and iron during flotation. The purpose of this invention is to fully replace zinc sulfate, reducing the dosage of the replacement depressant agent by up to 20 times less, furthermore reducing the amount of CuSO₄ used in the flotation process, among other improvements.

This is a U.S. national phase application under 35 U.S.C. § 371 of Patent Cooperation Treaty Application No. PCT/PE2020/050004, filed Feb. 24, 2020, which claims priority from Peruvian Application No. 001520-2019/DIN, filed on Aug. 1, 2019, and which incorporates by reference those PCT and Peruvian applications in their entireties.

### TECHNICAL FIELD

The present invention falls within the technical field of depressants for flotation processes; and refers, particularly, to a polymeric depressant for controlling the flotation of Zinc and Iron minerals.

### STATE OF THE ART

In the flotation processes of minerals of high commercial value such as copper, silver, gold, zinc, etc., the mining industry uses different types of chemical products in order to remove and control the flotation of certain metallic elements in the different stages of the process, in order to obtain a valuable mineral concentrate of the highest degree of purity and with the least amount of interferants so as to gather vast benefits per kilo of concentrate. Specifically, in the case of the flotation of polymetallic ore containing Zn sulfides and Fe sulfides (Pyrite, sphalerite, chalcopyrite and pyrrhotite), it is important to ensure that the least amount of iron goes into the valuable mineral concentrate containing sulfides or oxides of Cu, Zn, Ag, Pb, Au, etc. Also, it is essential to concentrate the zinc independently by means of a continuous process after concentrating the sulfides or oxides of Cu, Ag, Pb, Au, etc.

In the 60's and 70's reagent schemes were designed to recover as much gold and silver as possible. Although sodium cyanide was used extensively, the dose has been reduced due to the adverse effects it has on silver recovery. However, in those minerals that do not contain silver or gold, Zinc Sulfate (ZnSO₄) is being used in large quantities to deactivate the zinc flotation in the Rougher flotation process of copper and other elements and subsequently proceed to concentrate zinc in a later process.

Without a doubt, copper sulfate (CuSO₄) is the main zinc activator used in the Zinc circuit, the amount of added copper sulfate depends on the type of sphalerite present in the mineral. Low iron sphalerite (associated with pyrite or chalcopyrite) usually requires high CuSO₄ additions (for example, between 100 g/t and 500 g/t of Zinc); high iron sphalerite (strongly associated with pyrite, chalcopyrite or galena) requires low doses of CuSO₄; however, it in turn requires sodium cyanide to control the ingrained iron, making more difficult the method of recovery.

Flotation cells can be classified according to the flotation stages of the solid particles, as follows:
a) Rougher cells (devastating cells or primary flotation cells): it is through them that the primary concentrate is obtained. It consists of the set of cells whose foams are collected jointly with those of the cell where the pulp is fed to the circuit. This latter cell receives the pulp load from the conditioner or directly from the classifier.
b) Scavenger cells (recovery cells or exhausting cells): These are the cells where the recovery is performed for those valuable species that could not be recovered in the Rougher cells. There may be several of these processes: 1st. Scavenger, 2nd Scavenger, 3rd. Scavenger, etc. depending on the buoyancy of the valuable mineral.
c) Cleaner cells (Cells for cleaning): These are the cells where the cleaning of the primary concentrate or the Rougher flotation product is done.
d) Recleaner cells (cells for cleaning again): Are those cells where the cleaning of the foams from the Cleaner cells is carried out. If there are more than two cleaning stages, the cleaning cells are called of 1st. Cleaning, 2nd. Cleaning, 3rd. Cleaning, etc. depending on the difficulty for reaching the minimum commercialization grades that the final concentrate must have.

In regard to patents related to this proposed invention, in the state of the art there is the patent application AU2012203702A1, published on Jul. 19, 2012, which refers to a flotation process that includes the stages of adding an activating metal such as copper, nickel, manganese, zinc or the like, and combining it with a ligand (chelating agent) that makes possible changes in a pH range to modify the charge or the ionic nature of the ligand or complex. In particular, the ligand may be a fulvic acid, humic acid, other acids, and a mixture of them. The ligand has the structure R—(X) n in which X can be selected from amines, carboxyls, phosphonates and sulfonates; R can be an organic group and “n” can be from 1 to 4. Also, other reagents used in this patent are water and sodium hydroxide. Typical metals and minerals that could be recovered, separated and/or concentrated from ores include: — Platinum group minerals (PGM) from platinum-containing ores; — Recovery and separation of copper, zinc, lead, silver, gold from polymetallic metals and other base metals; — Gold and silver from ores containing gold; or— Sulfide minerals from ores that contain sulfur. Such mineral complexes keep metals in solution over a wide pH range.

However, said patent AU2012203702A1 doesn't allow its use in a flotation process of minerals that contain zinc sulfides and iron sulfides and to simultaneously avoid the use of ZnSO₄, for which purpose another compound can be used with up to 10 times less mass ratio, and also reducing up to one fourth the adding of CuSO₄, which implies substantial advantages in the transport and storage of high volumes of said chemical supplies. Furthermore, said patent AU2012203702A1 includes a metal ion which was selected from a list of activator metals, including it as an essential element of the formulation of such patent. In this regard, including a metal ion in a depressant would reduce its chelating potential, which enables it to control the Zn and Fe ions. If we were to add a metal ion in the initial flotation of the proposed invention by adding its salt, for example, CuSO₄, the latter would be an activator for Zinc, no longer making sense for the objective of the proposed invention which seeks to depress it, so it would act in a manner opposed to what is required. The depressant of the proposed invention contains humic acid treated with sodium or potassium hydroxide along with fulvic acid to act on the surface of zinc and iron, keeping them in suspension in the bulk, preventing them from floating to the surface, not being able to contribute to the mass of the ore recovered in the flotation.

Likewise, there is another patent application US20130025410A1, published on Jan. 31, 2013, which discloses a collector or foaming agent to be used in foam flotation processes for the recovery of commercially valuable metals from sulfide minerals (copper, zinc, lead, iron, molybdenum, etc.) or without sulfur (gold, etc.) that includes organic residues derived from treatment processes, selected aerobic or anaerobic decomposition of bio-solids and/or manure and/or humic substances. However, said patent US20130025410A1 is not suitable for use in a flotation process in minerals that contain zinc sulfides and iron sulfides and which in turn avoids the use of ZnSO₄ in its entirety, for which purpose another compound can be used with up to 10 times lower mass ratio, reducing the CuSO₄ addition by up to 25%, and decreasing the use of NaCN sodium cyanide by up to 50%, which implies substantial advantages in the transport and storage of industrial quantities of such chemical supplies.

Both patent precedents AU2012203702A1 and US20130025410A1 focus on the collection of metals; that is, they act to promote its recovery. However, it must be pointed out an important discordance with both antecedents, this proposed invention focuses on the depression of the metal that is not required in one stage and is released in a later stage.

### DESCRIPTION OF THE INVENTION

The present invention was developed as a solution to the aforementioned problems, establishing a production process for elaborating a depressant, defining the formula for such depressant agent and delineating a flotation process that includes the addition of said depressant agent.

In general, the present invention can work with low active matter content, for in some cases uses it diluted to 3% in plant or to 1% when working at laboratory level; such percentages can be used as a practical way to administer the appropriate dosage, with no possibility of error.

Considering the several possible water dilutions possible in the present invention, the process for producing the depressant agent would include the following steps, the elements are indicated in weight percentages: dissolve 1-40%, preferably 10-40%, humic acid, or humic acid derivatives, into 50-99%, preferably 50-80%, of water at a temperature between 15-30° C. and solubilize it by adding 0-10%, preferably 0.5-10%, of potassium hydroxide—the temperature will rise due to the solvation of potassium hydroxide (30-45° C.); leaving to react and homogenize for 20-60 minutes; reacting the previous product with 0.1-15%, preferably 1-15% fulvic acid to generate a product that controls zinc and iron during the flotation.

The formula of the depressant agent of this proposed invention includes the following elements in weight percentages: 1-40%, preferably 10-40%, of humic acid; 0-10%, preferably 0.5-10%, of potassium hydroxide; 0.1-15%, preferably 1-15%, of fulvic acid; 50-99%, preferably 50-80%, of water; and 0-5% of preservative, such preservative being an optional element. If the above proportions are exceeded, the depressant agent would depress valuable metals that are not intended to depress. On the other hand, at a lower rate, the result would be inefficient.

Furthermore, this proposed invention refers to a flotation process for the recovery of metals in minerals containing zinc sulfides and iron sulfides, which includes different stages/circuits, well known in the state of the art, according to the metals to be recovered and the desired degree of efficiency to be achieved in the flotation process. This flotation process may include crushing, grinding, rougher flotations (Rougher Pb and Rougher Zn), pre-flotation conditioning stages, recovery cells, cleaning cells, re-cleaning cells, etc. The essential and inventive part of these flotation processes is the addition of a depressant agent in a conditioning stage or in the primary grinding, in replacement of zinc sulfate; on which the depressant agent comprises 1-40% by weight, preferably 10-40%, of humic acid; 0-10% by weight, preferably 0.5-10%, of potassium hydroxide; 0.1-15% by weight, preferably 1-15%, of fulvic acid; 50-99% by weight, preferably 50-80% by weight of water, and 0.5% by weight of an optional preservative.

The proposed depressant agent is intended to fully replace ZnSO₄ in flotation processes in accordance with the state of the art (see state-of-the-art flotation process in FIG. 1) and even reduces the used dosage of mass by up to 10 times and can reduce it up to even 20 times. It is important that the mineral contains sulfides of Zn and Fe since the depression of them in the first stage of flotation or ROUGHER Pb (Ro Pb) is one of the main objectives of this invention. In a later flotation stage or ROUGHER Zn (Ro Zn), the depressant of this proposed invention allows the activation of zinc for its recovery, using a reduced amount of CuSO₄. The latter is a technical achievement or effect that has not been either observed or cannot be deduced from the antecedents.

Humic acid and fulvic acid act each over the surface of the metal sulphides by keeping them suspended in the solution and preventing them from floating. Humic acid acts as a natural chelator which, in turn, acts on the Zn and Fe ions under alkaline conditions by controlling their mobility; by adding the CuSO₄ activator in preferably a second stage, copper replaces zinc, causing Zn to be released and to float with the aid of the collector.

### BRIEF DESCRIPTION OF THE FIGURES

In order to complete the description that is being made and to facilitate the understanding of the characteristics of the invention, a set of figures is attached to the present specification in which, with an illustrative and non-limiting nature, some examples of embodiments are shown. In what follows, it should be understood that the proposed depressant agent has been designated as RA058.

FIG. 1: A process carried out using ZnSO₄ in the initial stage of the flotation process, in accordance to how it has been carried out in the state of the art; where the chemical supplies legend is:

Lime: Calcium oxide; RA-055: Product based on oligosaccharides for Pyrite control, from the company Resco S.A; AP3418: Dithiophosphine-based collector from the company CYTEC S.A. (Aerophine 3418); Z-11: Sodium isopropyl xanthate.

FIG. 2: A process performed using the depressant agent of this proposed invention RA058; where the chemical supplies legend is:

Lime: Calcium oxide; RA-055: Product based on oligosaccharides for Pyrite control from the company Resco S.A; AP3418: Dithiophosphine-based collector from the company CYTEC S.A. (Aerophine 3418); Z-11: Sodium isopropyl xanthate.

FIG. 3: Intermediate reactions produced in the process of preparation of the depressant agent.

FIG. 4: Table of head grades for the flotation process of a mineral X (Example of implementation).

FIG. 5: Table of recovery of metals in standard X-mineral flotation, using ZnSO₄ (State of the Art).

FIG. 6: Table of recovery of metals in alternating flotation of mineral X, using depressant agent RA058 (Proposed invention).

FIG. 7: Rougher Pb recovery comparison chart between the process using ZnSO₄ and the proposed process using RA058.

FIG. 8: Rougher Zn recovery comparison chart between the process employing ZnSO₄ and the proposed process employing RA058.

### PREFERRED MODALITIES OF EMBODIMENTS AND/OR DETAILED DESCRIPTION OF THE FIGURES

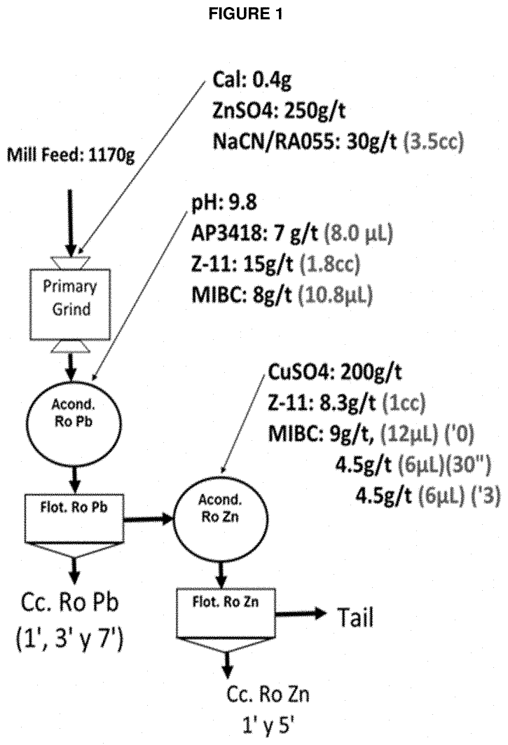

FIG. 1 shows an example of an embodiment of a state-of-the-art conventional flotation process in which 250 g/t of ZnSO₄ and 30 g/t of NaCN are added at a primary grinding stage. A Rougher Pb conditioning stage is then performed, a Rougher Pb flotation is carried out, 200 g/t is added in a Rougher Zn conditioning stage and then the Rougher Zn flotation is completed.

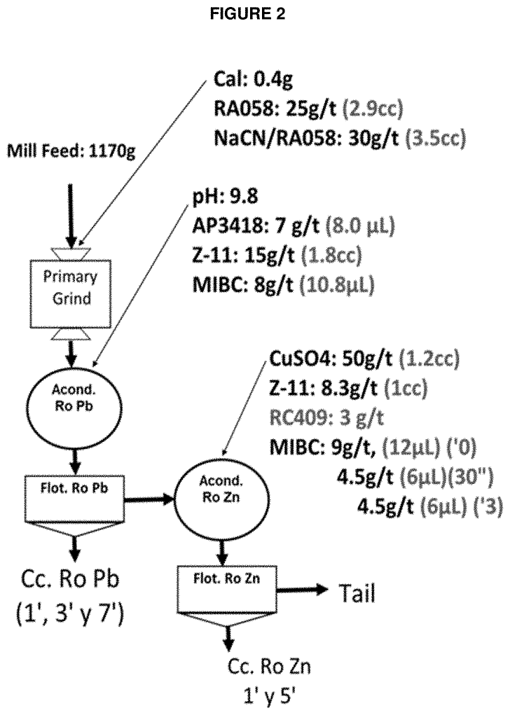

FIG. 2 shows the process under similar conditions of FIG. 1; however, instead of using 250 g/t of ZnSO₄, only 25 g/t of the depressant agent proposed in the present invention (RA058) is used. Also, 30 g/t of a mixture is added in a 1:1 ratio of NaCN with the proposed depressant agent, which means that only 50 g/t of CuSO₄ has to be used in the Rougher Zn conditioning stage.

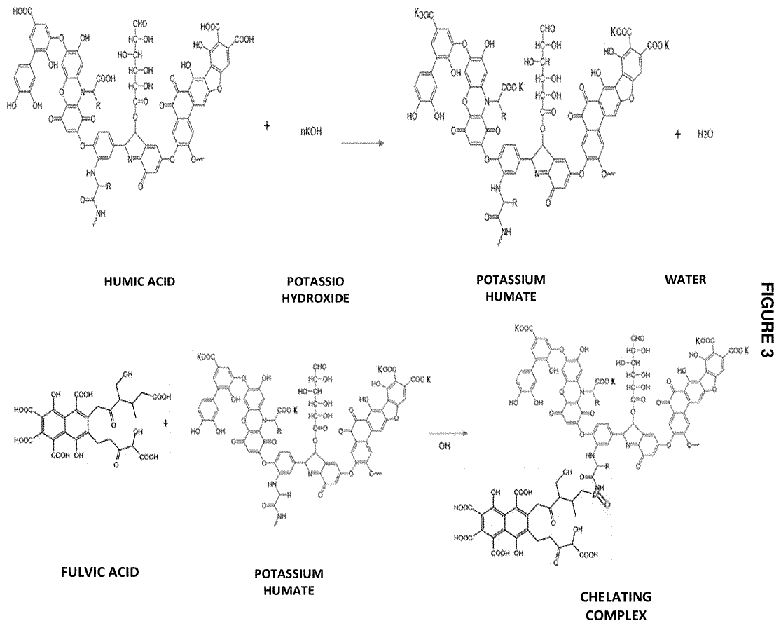

FIG. 3 shows an example of the reactions that occur in the process of preparation of the proposed depressant agent, ultimately generating a potassium carboxylated phenolic ester (chelating complex).

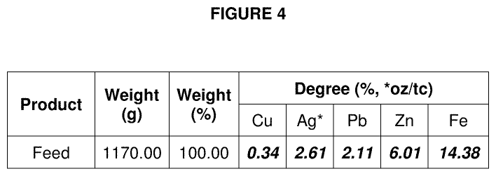

FIG. 4 shows the head grades of the example of embodiment of 1170 g of mineral with which the processes of FIGS. 1 and 2 are carried out. It is observed that the mineral contains Zinc and Fe in greater proportion than the other metals present therein.

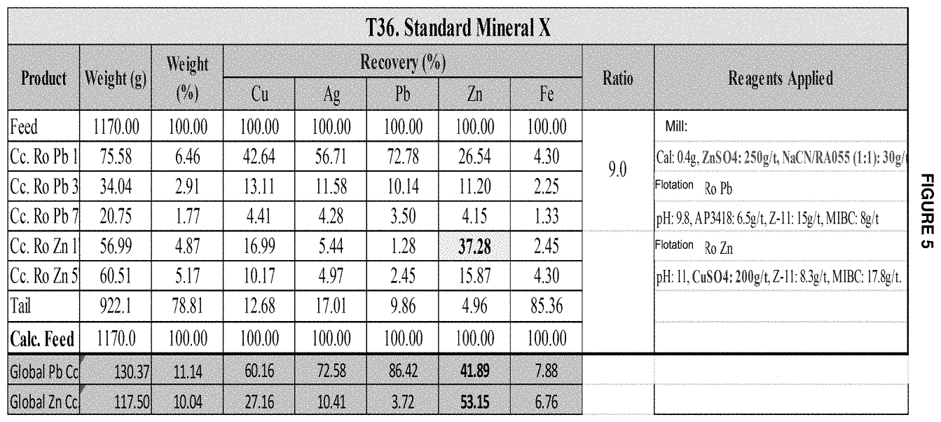

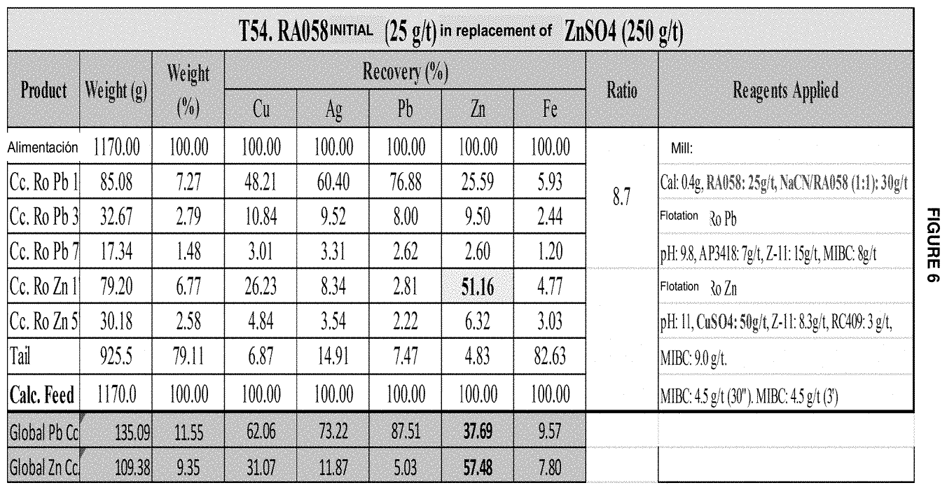

FIG. 5 shows the table for the flotation of a mineral X, according to the Head Grade shown above, this mineral which is treated with the conventional process uses 250 g/t of ZnSO₄ and in the second stage of zinc flotation uses 200 g/t of CuSO₄. It can be observed that such quantities are very high amounts of ZnSO₄ compared to the amounts that are used of the proposed depressant agent and that leads to a substantial saving in CuSO₄ employment according to FIG. 6.

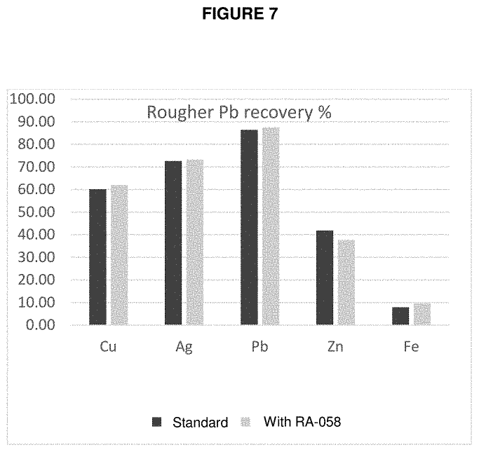

FIG. 7 shows the circuit of Pb or Rougher Pb, on which it is required to obtain the minimum amount of Zn; it has been possible to obtain a smaller amount of zinc (37.69%) than the conventional or standard process. Furthermore, the recoveries of Cu, Ag and Pb have been slightly increased.

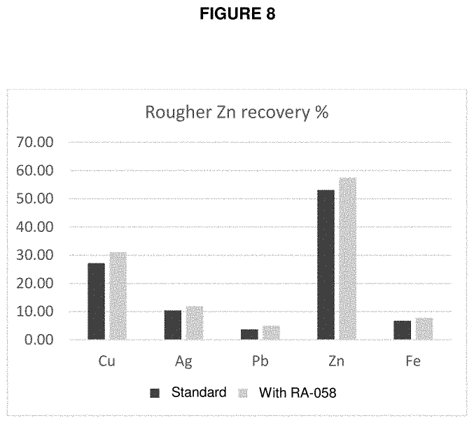

FIG. 8 shows the Zn or Zn Rougher circuit, on which the most Zn is required to obtain. A 57.48% recovery rate of Zn has been achieved, which is higher than the percentage of the standard process.

From the above lines, it can be confirmed that RA-058 replaces ZnSO₄ and improves the Zinc depression in the Pb—Zn circuit and in turn improves the recovery of Zinc in the Rougher Zinc circuit. It also generates improvements in the recovery of Cu and Pb as it reduces the amount of CuSO4 in the system and this decrease helps to improve the recovery of these elements.

Herein, it has been established that this invention can be used in minerals containing Zn sulphides and/or Fe sulphides. However, it is understood that variants may be made to act on other sulphides such as lead. The depressant agent of this proposed invention does not include one or more metal ions.

Humic acid (DAH) derivatives include mixtures of humic acid, ulmic acid and fulvic acid, sodium or potassium humates, and are products or transformations of organic matter by soil microorganisms.

It is recommended to use the depressant agent RA-058 gradually, dosing from less to more, taking into account that initially the system will still have remnants of ZnSO₄. According to the dosage of RA-058 evaluated in the laboratory, find the dose of RA-058 to be used, starting at the most at one tenth of the ZnSO₄ utilized. In the plant it may be lower than in the laboratory because of the circulating loads in the flotation system.

Some additional advantages of this proposed invention are:
The depressant agent or reagent RA-058, at appropriate doses, depresses zinc and iron minerals with similar performance as zinc sulfate, with the advantage that its use replaces 100% zinc sulfate by a reduced amount of 10 or more times the usual consumption plus easier operational handling.
In bulk Pb—Ag flotation, when dosing RA-058, recovery can be optimized with a slight increase of the selective collector.
The use of RA-058 at lower doses implies requiring lower doses of CuSO₄ activator for the flotation of Zinc minerals.
The use of the RA-058 reagent can alleviate the effect of Sulfates in flotation, which usually brought with it the creation of complex flotation systems, especially in Zinc flotation. This means that the use of RA-058 not only depresses Zinc minerals, but can improve the metallurgical performance in the Zinc circuit.
The lower dose of CuSO₄ in Zn flotation has a positive effect over time, since having a lower presence of CuSO₄ in the solution existing in tailings water, would have the effect of decreasing activation-displacement of Zn in the Cu/Ag/Pb circuit and/or Zn in Cu, increasing Zn recovery.

With the intention of giving a sufficiently broad protection to cover possible third-party modifications to the present invention on the basis of the same functionality as proposed, it is pointed out that humic acid can be replaced by any other phenol carboxylic poly-acid and fulvic acid by any other modified carboxylic acid. Thus, more broadly, it would have a process of elaboration of the depressant agent that includes a phenol carboxylic poly-acid, such as humic acid or its derivatives, dissolved in water, which is solubilized by adding potassium or sodium hydroxide, resulting in a high solubility carboxylated phenolate, this compound is then reacted with a modified carboxylic acid, such as fulvic acid, to generate a potassium carboxylated phenolic ester. Fulvic acid contains 10% less carbon and 10% more oxygen than humic acid; total acidity and content of —COOH in fulvic acids is significantly larger than humic acids so the name carboxylic acid predominates and the “modified” designation refers to that it is not an aliphatic linear chain that accompanies it but rather groups derived from carboxylated phenols.

As mentioned above, the present invention can operate with low active matter content, for, in some cases, it is used diluted to 3% in plant or to 1% when working at laboratory level, making the other components 1% by weight or less. In this sense, the proportions of the formulation of the present invention would be: 1-30% by weight of humic acid; 70-99% by weight of water; 0.1-15% by weight of fulvic acid; 0.5-10% by weight of potassium hydroxide.

Humic acid is more stable than fulvic acid in the presence of potassium hydroxide that is why if the amount of humic acid is reduced it also must be considerably reduced the amount of fulvic acid in order to maintain the stability and performance of the product.

1. A process to elaborate the depressant agent CHARACTERIZED BY including the stages of:
dissolving 5-40% by weight of humic acid, or humic acid derivatives, in 50-99% by weight of water at a temperature between 15-30° C. and solubilizing it by adding 0-10% by weight of potassium hydroxide; leaving to react and homogenize for 20-60 minutes; leaving to react the latter product with 0.1-15% by weight of a fulvic acid to generate a product that controls zinc and iron during flotation.

2. The process of elaborating the depressant agent, in accordance with claim 1, CHARACTERIZED BY comprising the stages of:
dissolving 10-40% by weight of humic acid or humic acid derivatives in 50-80% by weight of water at a temperature between 15-30° C. and solubilizing it by adding 0.5-10% by weight of potassium hydroxide; leaving to react and homogenize for 20-60 minutes;
allowing the reaction of the latter product with 1-15% by weight of a fulvic acid to generate a product that fulfils the function of controlling zinc and iron in the flotation process.

3. The process of elaborating the depressant agent, in accordance with claim 1, CHARACTERIZED BECAUSE humic acid derivatives include humates and fulvates of sodium and potassium.

4. The process of elaborating the depressant agent, in accordance with claim 1, CHARACTERIZED BECAUSE the stage of adding a preservative is incorporated.

5. The depressant agent to replace zinc sulfate in a flotation process, in accordance with claim 1, CHARACTERIZED BY comprising 1-40% by weight of humic acid or humic acid derivatives; 0-10% by weight of potassium hydroxide; 0.1-15% by weight of fulvic acid; and, 50-99% by weight of water.

6. The depressant agent which serves to replace zinc sulfate in a flotation process, in accordance with claim 5, CHARACTERIZED BY comprising 10-40% by weight of humic acid or humic acid derivatives; 0.5-10% by weight of potassium hydroxide or sodium hydroxide; 1-15% by weight of fulvic acid; and, 50-80% by weight of water.

7. The depressant agent, in accordance with claim 5, CHARACTERIZED BY comprising the addition of a preservative.

8. A flotation process for the recovery of metals in minerals containing zinc sulfides and iron sulfides, in accordance with claim 1, CHARACTERISED BY the addition of a depressant agent at a conditioning stage or in primary grinding, as a replacement for zinc sulfate; where the depressant agent comprises 1-40% by weight of humic acid, 0-10% by weight of potassium hydroxide, 0.1-15% by weight of fulvic acid and 50-99% by weight of water.

9. The flotation process, in accordance with claim 8, CHARACTERIZED BY adding a depressant agent in a conditioning stage or in the primary grinding, in replacement of zinc sulfate; where the depressant agent consists of 10-40% by weight of humic acid, 0.5-10% by weight of potassium hydroxide, 1-15% by weight of fulvic acid and 50-80% by weight of water.

10. The flotation process, according to claim 8, CHARACTERIZED BECAUSE a preservative is added in the depressant agent.
